(19) United States
(12) Patent Application Publication
(10) Pub. No.: US 2021/0360389 A1
(43) Pub. Date: Nov. 18, 2021

(54) REFERENCE SIGNAL CONFIGURATION GROUPS AND DYNAMIC REFERENCE SIGNAL CONFIGURATION SELECTION

(71) Applicant: QUALCOMM Incorporated, San Diego, CA (US)

(72) Inventors: Michael LEVITSKY, Rehovot (IL); Assaf TOUBOUL, Netanya (IL); Shay LANDIS, Hod Hasharon (IL); Ran BERLINER, Kfar-Aviv (IL)

(21) Appl. No.: 16/876,791

(22) Filed: May 18, 2020

(51) Int. Cl. H04W 8/24; H04L 5/00; H04W 76/11; H04W 80/02; H04W 72/04; H04L 5/10; H04B 7/06

(52) U.S. Cl. CPC H04W 8/24; H04L 5/0051; H04W 76/11; H04B 7/0626; H04W 72/042; H04L 5/10; H04W 80/02

(57) ABSTRACT

Various aspects of the present disclosure generally relate to wireless communication, reference signal configuration aspects, and dynamic and synchronous configuration signaling. In some aspects, a user equipment (UE) may transmit, to a base station (BS), an indication of a UE capability to support a reference signal configuration group of a plurality of reference signal configuration groups. The UE may receive, from the BS, an indication of a reference signal configuration from the reference signal configuration group. The indication if the reference signal configuration may be provided by the BS to dynamically configure a reference signal and can be provided by means of medium access control control element (MAC-CE) based activation or by means of activation of a subset of reference signal configurations with a complementary downlink control information (DCI) based selection of one of the activated reference signal configurations. Numerous other aspects are provided.

### CROSS-REFERENCE TO RELATED APPLICATIONS

This application is related to several applications all having the same filing date of this application. These include: U.S. application Ser. No. 16/876,372 (entitled “USER EQUIPMENT ASSISTED DEMODULATION REFERENCE SIGNAL CONFIGURATION SELECTION”) (QC Docket No. 200721); U.S. application Ser. No. 16/876,449 (entitled “UPLINK DOPPLER METRIC ESTIMATION BASED ON AN UPLINK REFERENCE SIGNAL”) (QC Docket 200722U1); and U.S. application Ser. No. 16/876,575 (entitled “UPLINK DOPPLER METRIC ESTIMATION BASED ON A DOWNLINK REFERENCE SIGNAL”) (QC Docket 200722U2). All of said applications are hereby incorporated by reference as if fully set forth below.

### TECHNICAL FIELD

Aspects of the technology described below generally relate to wireless communication and to techniques and apparatuses for reference signal configuration groups and dynamic reference signal configuration selection. Some techniques and apparatuses described herein enable and provide wireless communication devices and systems configured for enhanced wireless communication performance.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. A BS may be referred to as a Node B, a gNB, an access point (AP), a radio head, a transmit receive point (TRP), a new radio (NR) BS, a 5G Node B, and/or the like.

Multiple access technologies have been adopted in various telecommunication standards. Wireless communication standards provide common protocols to enable different devices (e.g., user equipment) to communicate on a municipal, national, regional, and even global level. New radio (NR), which may also be referred to as 5G, is a set of enhancements to the LTE mobile standard promulgated by the Third Generation Partnership Project (3GPP). As demand for mobile broadband access continues to increase, there exists a need for further improvements in LTE and NR technologies. These improvements can apply to other multiple access technologies and the telecommunication standards that employ these technologies.

### BRIEF SUMMARY OF SOME EXAMPLES

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. The purpose of the summary is to present some concepts of one or more aspects of the disclosure in summary form as a prelude to the more detailed description that is presented later.

Wireless communication devices (e.g., user equipment (UEs), base stations (BSs), and/or the like) in a wireless network may transmit various types of reference signals, such as a demodulation reference signal (DMRS), a channel state information reference signal (CSI-RS), a phase tracking reference signal (PTRS), an uplink sounding reference signal (SRS), a downlink tracking reference signal (TRS), and/or the like. In some cases, a reference signal may be configured with a limited set of options specified in a specification. While this provides some configuration flexibility, the parameters for the reference signal are typically configured via a static radio resource control (RRC) configuration.

UEs in a wireless network may experience different channel parameters and/or signal to noise ratio (SNR) conditions. Moreover, the channel parameters and/or SNR conditions for a UE may vary over time due to mobility of the UE. Different channel parameters and SNR conditions may be better suited for different reference signal configurations. However, due to the static nature of reference signal configurations, a BS may be unable to modify or select different reference signal configurations to accommodate changes in channel parameters and SNR conditions, which may result in inefficient reference signal usage (e.g., reference signals may be transmitted at a greater frequency density and/or time density than needed, which wastes radio resources, processing resources, memory resources, and battery resources) and/or degraded wireless communication performance (e.g., an increase in channel estimation errors may occur when reference signal density is too low, causing low channel correlation values).

According to some techniques and apparatuses described herein, a plurality of reference signal configuration groups may be configured. The reference signal configuration groups may include different quantities of reference signal configurations for a particular type of reference signal. The reference signal configurations included in a reference signal configuration group may be selected from a pool of defined reference signal configurations (e.g., as configured in a specification, a table, a standard, and/or the like). A UE may signal, to a BS, a supported reference signal configuration group for the UE from the plurality of reference signal configuration groups based at least in part on one or more signaled UE capabilities. For example, if the UE is a reduced capability UE, the UE may select a reference signal configuration group that includes a lower quantity of reference signal configurations. On the other hand, if the UE is a higher-capability UE, the UE may select a reference signal configuration group that includes a greater quantity of reference signal configurations.

In some aspects, the BS may be capable of dynamically activating and/or selecting a reference signal configuration from the reference signal configuration group for communication with the UE. In some aspects, the UE may signal a selected reference signal configuration to the BS. In some aspects, the BS may select the reference signal configuration based at least in part on channel parameters and/or SNR conditions for the UE. As a result, some techniques or apparatuses described herein may enable the UE and/or the BS to select different reference signal configurations to accommodate changes in channel parameters and SNR conditions, which may result in efficient reference signal usage and/or enhanced wireless communication performance.

In some aspects, a method of wireless communication, performed by a user equipment, may include transmitting, to a BS, an indication of a reference signal configuration group of a plurality of reference signal configuration groups; receiving, from the BS, an indication of a reference signal configuration from the reference signal configuration group; and communicating with the BS using the reference signal configuration based at least in part on the indication of the reference signal configuration.

In some aspects, a method of wireless communication, performed by a base station, may include receiving, from a user equipment (UE), an indication of a reference signal configuration group of a plurality of reference signal configuration groups; transmitting, to the UE, an indication of a reference signal configuration from the reference signal configuration group; and communicating with the UE using the reference signal configuration after transmitting the indication of the reference signal configuration.

In some aspects, a user equipment for wireless communication may include a memory and one or more processors operatively coupled to the memory. The memory and the one or more processors may be configured to transmit, to a base station (BS), an indication of a reference signal configuration group of a plurality of reference signal configuration groups; receive, from the BS, an indication of a reference signal configuration from the reference signal configuration group; and communicate with the BS using the reference signal configuration based at least in part on the indication of the reference signal configuration.

In some aspects, a base station for wireless communication may include a memory and one or more processors operatively coupled to the memory. The memory and the one or more processors may be configured to receive, from a user equipment (UE), an indication of a reference signal configuration group of a plurality of reference signal configuration groups; transmit, to the UE, an indication of a reference signal configuration from the reference signal configuration group; and communicate with the UE using the reference signal configuration after transmitting the indication of the reference signal configuration.

In some aspects, a non-transitory computer-readable medium may store one or more instructions for wireless communication. The one or more instructions, when executed by one or more processors of a user equipment, may cause the one or more processors to transmit, to a BS, an indication of a reference signal configuration group of a plurality of reference signal configuration groups; receive, from the BS, an indication of a reference signal configuration from the reference signal configuration group; and communicate with the BS using the reference signal configuration based at least in part on the indication of the reference signal configuration.

In some aspects, a non-transitory computer-readable medium may store one or more instructions for wireless communication. The one or more instructions, when executed by one or more processors of a base station, may cause the one or more processors to receive, from a UE, an indication of a reference signal configuration group of a plurality of reference signal configuration groups; transmit, to the UE, an indication of a reference signal configuration from the reference signal configuration group; and communicate with the UE using the reference signal configuration after transmitting the indication of the reference signal configuration.

In some aspects, an apparatus for wireless communication may include means for transmitting, to a BS, an indication of a reference signal configuration group of a plurality of reference signal configuration groups; means for receiving, from the BS, an indication of a reference signal configuration from the reference signal configuration group; and means for communicating with the BS using the reference signal configuration based at least in part on the indication of the reference signal configuration.

In some aspects, an apparatus for wireless communication may include means for receiving, from a UE, an indication of a reference signal configuration group of a plurality of reference signal configuration groups; means for transmitting, to the UE, an indication of a reference signal configuration from the reference signal configuration group; and means for communicating with the UE using the reference signal configuration after transmitting the indication of the reference signal configuration.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description is provided herein, with some aspects of the disclosure being illustrated in the appended drawings. However, the appended drawings illustrate only some aspects of this disclosure and are therefore not to be considered limiting of the scope of the disclosure. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a UE in a wireless communication network, in accordance with various aspects of the present disclosure.

FIG. 3A is a diagram illustrating an example of reference signal configuration groups, in accordance with various aspects of the present disclosure.

FIG. 3B is a diagram illustrating an example of a reference signal configuration, in accordance with various aspects of the present disclosure.

FIG. 4 is a diagram illustrating an example of reference signal configuration groups and dynamic reference signal configuration selection, in accordance with various aspects of the present disclosure.

FIG. 5 is a diagram illustrating an example of reference signal configuration groups and dynamic reference signal configuration selection, in accordance with various aspects of the present disclosure.

FIG. 6 is a diagram illustrating an example process performed, for example, by a user equipment, in accordance with various aspects of the present disclosure.

FIG. 7 is a diagram illustrating an example process performed, for example, by a base station, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements” or “features”). These elements may be implemented using hardware, software, or combinations thereof. Whether such elements are implemented as hardware or software depends upon the particular application and design constraints imposed on the overall system.

While some aspects may be described herein using terminology commonly associated with 3G and/or 4G wireless technologies, aspects of the present disclosure can be applied in other generation-based communication systems, such as 5G and later, including NR technologies.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and/or other non-module-component based devices (e.g., end-user devices, vehicles, communication devices, computing devices, industrial equipment, retail/purchasing devices, medical devices, AI-enabled devices, and/or the like). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including one or more antennas, RF-chains, power amplifiers, modulators, buffers, processors, interleavers, adders/summers, and/or the like). It is intended that innovations described herein may be practiced in a wide variety of devices, chip-level components, systems, distributed arrangements, end-user devices, etc. of varying sizes, shapes, and constitution.

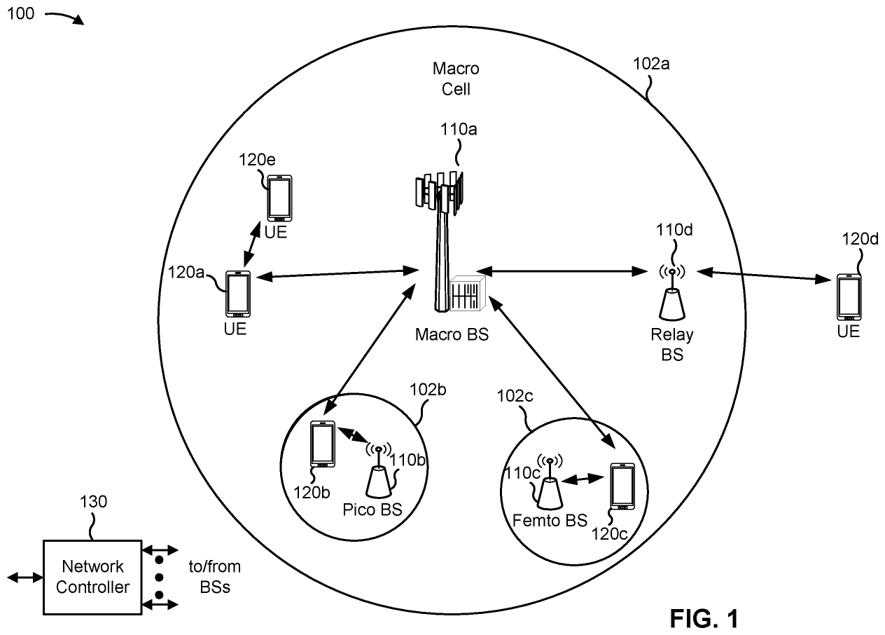

FIG. 1 is a diagram illustrating a wireless network 100 in which aspects of the present disclosure may be practiced. For example, a base station and a user equipment may communicate in the wireless network 100. The base station and/or the user equipment may transmit one or more types of reference signals in the wireless network 100. In some aspects, a plurality of reference signal configuration groups may be defined. In some aspects, the base station may dynamically select a reference signal configuration from a reference signal configuration group of the plurality of reference signal configuration groups. The base station and the user equipment may communicate in the wireless network 100 using the dynamically selected reference signal configuration.

The wireless network 100 may be an LTE network or some other wireless network, such as a 5G or NR network. The wireless network 100 may include a number of BSs 110 (shown as BS 110a, BS 110b, BS 110c, and BS 110d) and other network entities. A BS is an entity that communicates with user equipment (UEs) and may also be referred to as a base station, a NR BS, a Node B, a gNB, a 5G node B (NB), an access point, a transmit receive point (TRP), and/or the like. In some deployments, a BS may be known as a scheduling entity (e.g., in that the base station can schedule communications of other devices). Each BS may provide communication coverage for a particular area (e.g., a fixed or changing geographical area). In some scenarios, BSs 110 may be stationary or non-stationary. In some non-stationary scenarios, mobile BSs 110 may move with varying speeds, direction, and/or heights. In 3GPP, the term “cell” can refer to a coverage area of a BS 110 and/or a BS subsystem serving this coverage area, depending on the context in which the term is used. BSs and UEs may communicate by transmitting various types of wireless communications, such as wireless data communications, wireless control communications, reference signals, and/or the like.

A BS may provide communication coverage for areas of varying sizes or ranges. BSs can be configured to enable communication in a variety of cell arrangements, including a macro cell, a pico cell, a femto cell, and/or another type of cell. A macro cell may cover a relatively large geographic area (e.g., several kilometers in radius) and may allow unrestricted access by UEs with service subscription. Additionally, or alternatively, a BS may support access to an unlicensed RF band (e.g., a Wi-Fi band and/or the like). A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary. A cell that is mobile enables a geographic area of the cell to move according to the location of a mobile BS. In some aspects, a UE can be configured to carry out BS functionality. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network. In other scenarios, BSs may be implemented in a software defined network (SDN) manner or via network function virtualization (NFV) manner.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicle, a vehicular component or sensor, smart meters/sensors, industrial manufacturing equipment, robotics, drones, implantable devices, augmented reality devices, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as may be implemented as NB-IoT (narrowband internet of things) devices. Some UEs may be considered a Customer Premises Equipment (CPE). UE 120 may be included inside a housing that houses components of UE 120, such as processor components, memory components, and/or the like. These components may be integrated in a variety of combinations and/or may be stand-alone, distributed components considering design constraints and/or operational preferences. Further, in some deployments, UEs may be referred to as scheduled entities (e.g., in that UE communication may be scheduled by another entity, such as a BS or another scheduling entity).

In general, any number of wireless networks may be deployed in a given geographic area. That is, multiple wireless networks can exist and can be deployed simultaneously in a given area. Some devices can be multi-mode devices and can be configured to communicate with multiple networks. In some deployments, devices may operate with only one network, with only a limited number of networks, and/or with only a particular type of network (e.g., a 5G stand-alone device). Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110. A UE performing scheduling operations can include or perform base-station-like functions in these deployment scenarios.

As indicated above, FIG. 1 is provided merely as an example. Other examples may differ from what is described with regard to FIG. 1.

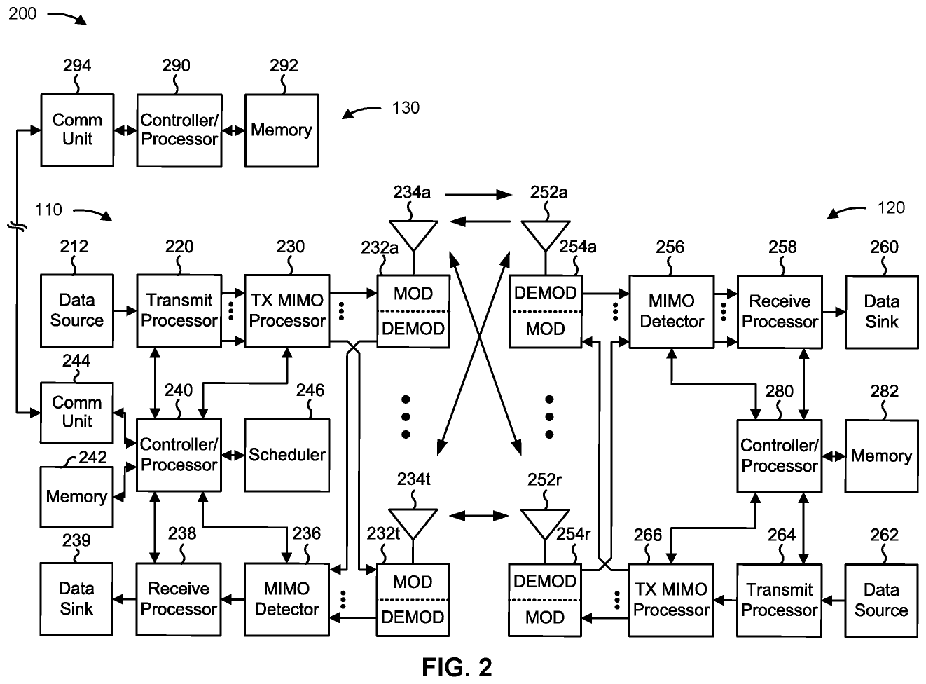

FIG. 2 shows a block diagram of a design 200 of base station 110 and UE 120, which may be one of the base stations and one of the UEs in FIG. 1. For example, the base station 110 and the UE 120 may communicate in the wireless network 100. The base station 110 and/or the UE 120 may transmit one or more types of reference signals in the wireless network 100. In some aspects, a plurality of reference signal configuration groups may be defined. In some aspects, the base station 110 may dynamically select a reference signal configuration from a reference signal configuration group of the plurality of reference signal configuration groups. The base station 110 and the UE 120 may communicate in the wireless network 100 using the dynamically selected reference signal configuration.

Base station 110 may be equipped with T antennas 234a through 234t, and UE 120 may be equipped with R antennas 252a through 252r, where in general T≥1 and R≥1. The T and R antennas may be configured with multiple antenna elements formed in an array for MIMO or massive MIMO deployments that can occur in millimeter wave (mmWave or mmW) communication systems.

At base station 110, a transmit processor 220 can carry out a number of functions associated with communications. For example, transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive downlink RF signals. The downlink RF signals may be received from and/or may be transmitted by one or more base stations 110. The signals can be provided to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing.

For uplink communications, a UE 120 may transmit control information and/or data to another device, such as one or more base stations 110. For example, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

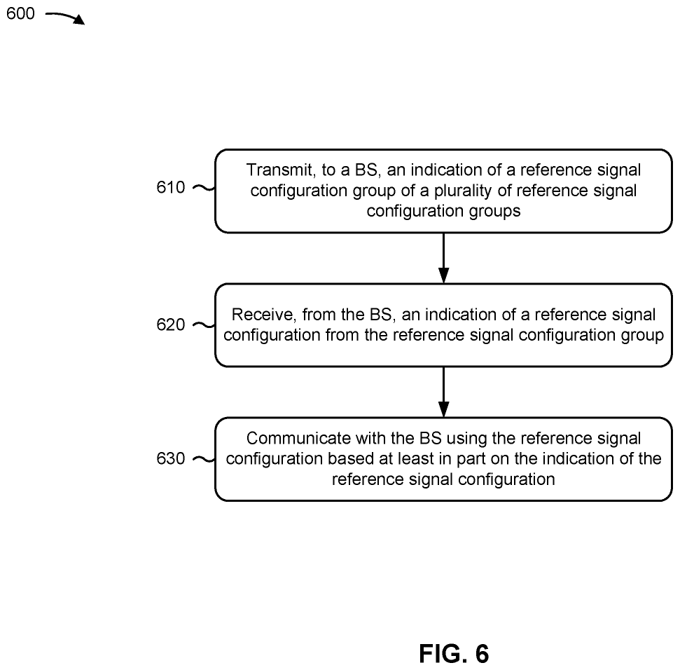

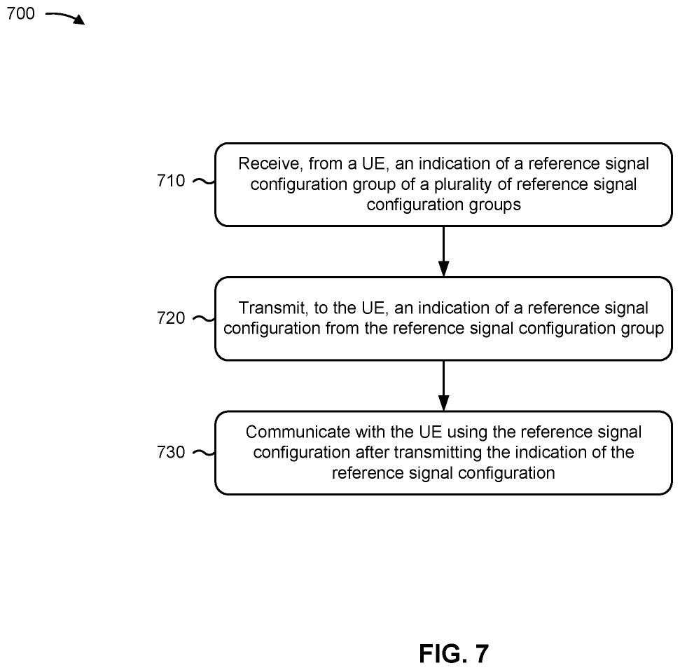

Controller/processor 240 of base station 110, controller/processor 280 of UE 120, and/or any other component(s) of FIG. 2 may perform one or more techniques associated with reference signal configuration groups and dynamic reference signal configuration selection, as described in more detail elsewhere herein. For example, controller/processor 240 of base station 110, controller/processor 280 of UE 120, and/or any other component(s) of FIG. 2 may perform or direct operations of, for example, process 600 of FIG. 6, process 700 of FIG. 7, and/or other processes as described herein. Memories 242 and 282 may store data and program codes for base station 110 and UE 120, respectively. A scheduler 246 may schedule UEs for data transmission on the downlink and/or uplink.

In some aspects, the UE 120 may include a variety of means or components for implementing communication functions. For example, the variety of means may include means for transmitting, to a BS, an indication of a reference signal configuration group of a plurality of reference signal configuration groups, means for receiving, from the BS, an indication of a reference signal configuration from the reference signal configuration group, means for communicating with the BS using the reference signal configuration based at least in part on the indication of the reference signal configuration, and/or the like.

In some aspects, the UE 120 may include a variety of structural components for carrying out functions of the various means. For example, structural components that carry out functions of such means may include one or more components of UE 120 described in connection with FIG. 2, such as antenna 252, DEMOD 254, MOD 254, MIMO detector 256, receive processor 258, transmit processor 264, TX MIMO processor 266, controller/processor 280, and/or the like.

In some aspects, the base station 110 may include a variety of means or components for implementing communication functions. For example, the variety of means may include means for receiving, from a UE, an indication of a reference signal configuration group of a plurality of reference signal configuration groups, means for transmitting, to the UE, an indication of a reference signal configuration from the reference signal configuration group, means for communicating with the UE using the reference signal configuration after transmitting the indication of the reference signal configuration, and/or the like.

In some aspects, the base station 110 may include a variety of structural components for carrying out functions of the various means. For example, structural components that carry out functions of such means may include one or more components of base station 110 described in connection with FIG. 2, such as transmit processor 220, TX MIMO processor 230, DEMOD 232, MOD 232, antenna 234, MIMO detector 236, receive processor 238, controller/processor 240, and/or the like.

As indicated above, FIG. 2 is provided merely as an example. Other examples may differ from what is described with regard to FIG. 2.

Wireless communication devices (e.g., user equipment (UEs), base stations (BSs), and/or the like) in a wireless network may transmit various types of reference signals, such as a demodulation reference signal (DMRS), a channel state information reference signal (CSI-RS), a phase tracking reference signal (PTRS), a sounding reference signal (SRS), a tracking reference signal (TRS), and/or the like. In some cases, a reference signal may be configured with a limited set of options specified in a specification. While this provides some configuration flexibility, the parameters for the reference signal are typically configured via a static radio resource control (RRC) configuration.

UEs and BSs in a wireless network may experience different channel parameters and/or signal to noise ratio (SNR) conditions. Moreover, the channel parameters and/or SNR conditions for a UE and/or a BS may vary over time due to mobility of the UE and/or the BS. Different channel parameters and SNR conditions may be better suited for different reference signal configurations. However, due to the static nature of reference signal configurations, a BS may be unable to modify or select different downlink (DL) and/or uplink (UL) reference signal configurations to accommodate changes in channel parameters and SNR conditions, which may result in inefficient reference signal usage (e.g., reference signals may be transmitted using more dense mapping/allocation grid than needed, which wastes radio resources, processing resources, memory resources, and battery resources) and/or degraded wireless communication performance (e.g., an increase in channel estimation errors may occur when reference signal density is too low, causing low channel correlation values).

Some techniques and apparatuses described herein relate to reference signal configuration groups and dynamic reference signal configuration selection and signaling. In some aspects, a plurality of reference signal configuration groups may be configured. Each reference signal configuration group may include different quantities of reference signal configurations for a particular type of reference signal. The reference signal configurations included in each reference signal configuration group may be selected from a pool of defined reference signal configurations (e.g., as configured in a specification, a table, a standard, and/or the like). A UE may signal, to a BS, a specific reference signal configuration group supported by the UE. The UE may support the reference signal configuration group(s) from the plurality of reference signal configuration groups and signal to the BS the corresponding UE capability associated with the specific reference signal configuration group or groups. For example, if the UE is a reduced capability UE, the UE may select a reference signal configuration group that includes a lower quantity of reference signal configurations, whereas the UE may select a reference signal configuration group that includes a greater quantity of reference signal configurations if the UE is a higher-capability UE.

In some aspects, the BS may be capable of dynamically activating and/or selecting a reference signal configuration from the reference signal configuration group for communication with the UE. In some aspects, the UE may select the reference signal configuration and signal the reference signal indication to the BS. In some aspects, the BS may select the reference signal configuration based at least in part on channel parameters and/or SNR conditions for the UE. As a result, some techniques or apparatuses described herein may enable the BS select different reference signal configurations to accommodate changes in channel parameters and SNR conditions, which may result in efficient reference signal usage and/or enhanced wireless communication performance.

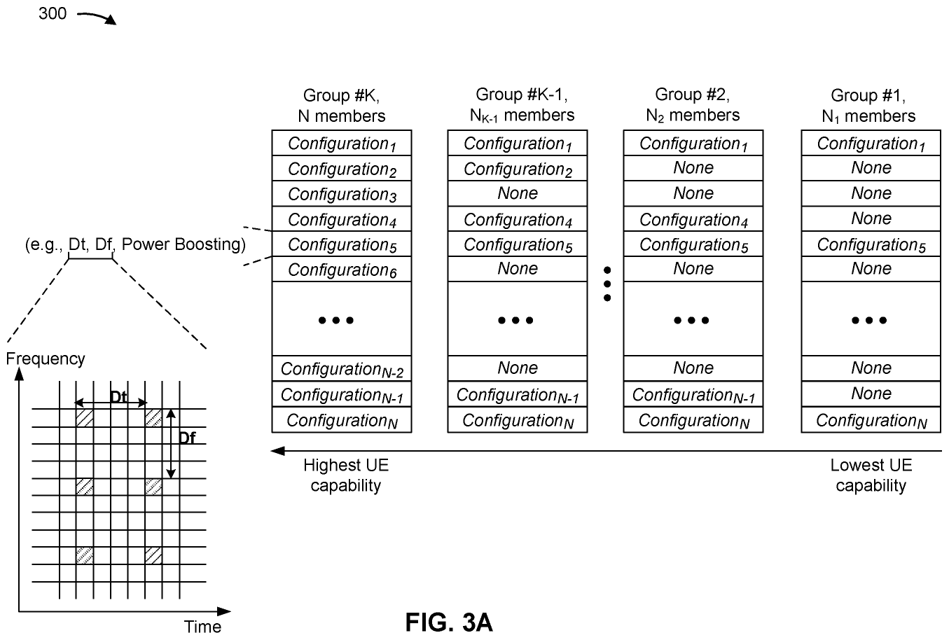

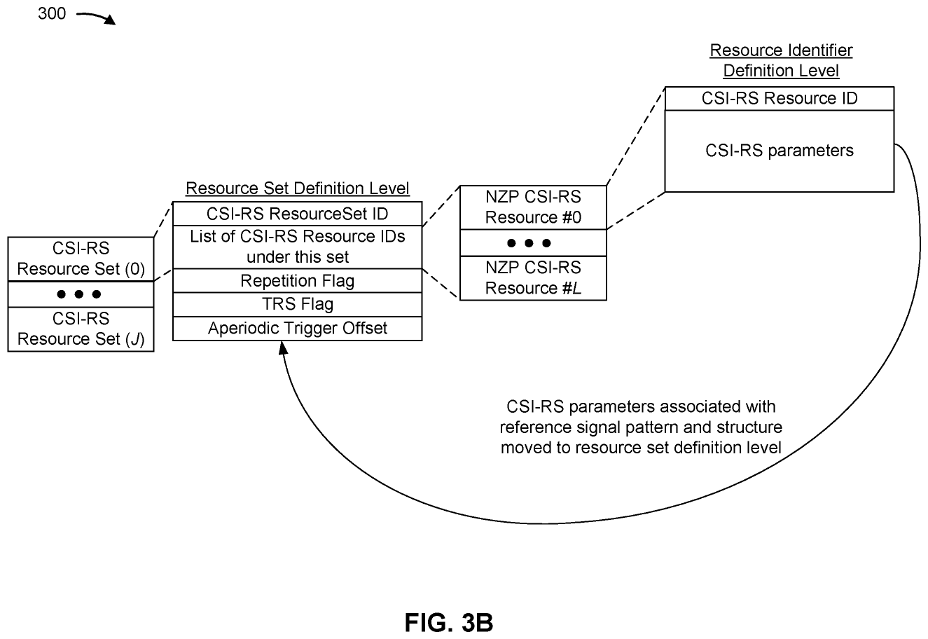

FIG. 3A is a diagram illustrating an example 300 of reference signal configuration groups, in accordance with various aspects of the present disclosure. As shown in FIG. 3A, a plurality of reference signal configuration groups may be defined based at least in part on a telecommunication specification such as a 3GPP 5G specification, a telecommunication standard, a wireless network (e.g., wireless network 100) associated with the plurality of reference signal configuration groups, a configuration of a BS associated with the plurality of reference signal configuration groups, a configuration or capability of a UE associated with the plurality of reference signal configuration groups, and/or the like. The plurality of reference signal configuration groups may be associated with various types of reference signals, such as a DMRS, a CSI-RS, a PTRS, and/or the like. For example, there may be a plurality of DMRS configuration groups, a plurality of CSI-RS configuration groups, a plurality of PTRS configuration groups, a plurality of SRS configuration groups, a plurality of TRS configuration groups, and/or the like.

In some aspects, the plurality of reference signal configuration groups may include a group 1 through a group K, where K is the total quantity of groups included in the plurality of reference signal configuration groups. In some aspects, each reference signal configuration group may include a respective plurality of reference signal configurations. The plurality of reference signal configurations may be DMRS configurations, CSI-RS configurations, PTRS configurations, and/or the like.

A reference signal configuration may indicate one or more parameters for a particular reference signal type (e.g., DMRS, CSI-RS, PTRS, and/or the like). In some aspects, the one or more parameters may include a time domain resource element spacing or density (e.g., Dt) for the reference signal type. The time domain resource element spacing or density may indicate a pilot resource element spacing in the time domain or equivalently the number of DMRS symbols per allocation. In some aspects, the time domain resource element spacing or density may be based at least in part on a number of symbols, such as a quantity of orthogonal frequency division multiplexing (OFDM) symbols.

In some aspects, the one or more parameters may include a frequency domain resource element spacing or density (e.g., Df) for the reference signal type or number of multiplexed RS ports per symbol equivalently. The frequency domain resource element spacing or density may indicate a pilot resource element spacing or density in the frequency domain.

In some aspects, the one or more parameters may include a power boosting parameter for the reference signal type. The power boosting parameter may indicate a relative power boosting (e.g., in decibels (dB)) of resource elements associated with the reference signal type compared to resource elements associated with data transmissions or associated with other RS type REs. In some cases, where a UE is in very low SNR conditions, increasing or boosting the transmit power of a reference signal may be used instead of (or in addition to) a high reference signal density (e.g., a high Df and/or a high Dt).

In some aspects, a plurality of reference signal configurations may be defined, where N is the total quantity of reference signal configurations defined. For example, a full list of reference signal configurations may include N total members. In some aspects, each of the plurality of reference signal configuration groups may include a different combination of the full list of reference signal configurations. For example, each of the plurality of reference signal configuration groups may include a respective subset of the full list of reference signal configurations.

In some aspects, the plurality of reference signal configuration groups may include different quantities of reference signal configurations. For example, group 1 may include a first quantity of reference signal configurations, group 2 may include a second quantity of reference signal configurations, group K-1 may include a third quantity of reference signal configurations, and group K may include a fourth quantity of reference signal configurations.

In some aspects, group 1 may include the lowest quantity of reference signal configurations (e.g., of the plurality of reference signal configuration groups) and group K may include the greatest quantity of reference signal configurations (e.g., of the plurality of reference signal configuration groups). In some aspects, group K may include the full list of reference signal configurations (e.g., such that group K includes N total reference signal configurations).

In some aspects, the quantity of reference signal configurations in a group may correspond to a UE capability associated with the group. For example, group 1 (e.g., with the lowest quantity of reference signal configurations) may be associated with the lowest UE capability. Group K (e.g., with the greatest quantity of reference signal configurations) may be associated with the highest UE capability. The UE capability may be based at least in part on the reference signal type (e.g., DMRS, CSI-RS, PTRS, SRS, TRS, and/or the like). The UE may transmit an indication of the UE capability to a BS and may include an indication of whether the UE can support one or more parameters or one or more reference signal configurations or one or more reference signal configuration groups. In some aspects, the UE capability may include an indication of a range of one or more parameters supported by the UE (e.g., a range of time domain resource element spacing or density for a reference signal type, a range of frequency domain resource element spacing or density for a reference signal type, a range of power boosting supported for a reference signal type, and/or the like).

As indicated above, FIG. 3A is provided as an example. Other examples may differ from what is described with respect to FIG. 3A.

FIG. 3B is a diagram illustrating an example 300 of a reference signal configuration, in accordance with various aspects of the present disclosure. In some aspects, example 300 may illustrates an example of a CSI-RS configuration. As discussed above, some techniques and apparatuses described herein may relate to various types of reference signals, such as DMRS, CSI-RS, PTRS, SRS, TRS, and/or the like.

In some aspects, a CSI-RS configuration may include one or more resource sets. Each resource set may include a resource set definition level, a single resource identifier definition level, and/or the like. The resource set definition level may include an indication of a CSI-RS resource set identifier that identifies a CSI-RS resource set (e.g., a non-zero power (NZP) CSI-RS ResourceSet ID), a list of CSI-RS resource identifications included in the CSI-RS resource set, a repetition flag, a TRS flag, an aperiodic trigger offset for an AP resource, and/or the like. In some aspects, the CSI-RS configuration may be used for various types of CSI-RSs, such as a periodic CSI-RS (e.g., scheduled via RRC signaling), a semi-persistent CSI-RS (e.g., scheduled via RRC or MAC-CE signaling), a dynamic or aperiodic CSI-RS (e.g., scheduled via downlink control information (DCI) signaling), and/or the like.

The resource identifier definition level may include one definitions for a single CSI-RS resource, such as a quantity of ports for the CSI-RS resource, a resource mapping for the CSI-RS resource, a scrambling identifier for the CSI-RS resource, and/or the like).

In some aspects, the one or more parameters indicated by a reference signal configuration (e.g., CSI-RS parameters) may be included in the resource identifier definition level of the CSI-RS configuration. For example, the CSI-RS parameters may include CSI-RS parameters associated with a reference signal pattern and structure, such as a time domain resource element spacing or density parameter or symbols location within a subframe, a frequency domain resource element spacing or density parameter, a power boosting parameter, and/or the like.

In some aspects, one or more CSI-RS parameters may be moved from the resource identifier definition level of the CSI-RS configuration to the resource set definition level of the CSI-RS configuration. In some aspects, all of the CSI-RS parameters may be moved to the resource set definition level of the CSI-RS configuration. As a result, the one or more parameters indicated by the reference signal configuration (e.g., as described above with respect to FIG. 3A) may be included at the resource set definition level of the CSI-RS configuration. In this way, the restructuring of the CSI-RS configuration allows for the use of DCI to select an activated reference signal configuration option(s) because aperiodic CSI-RS scheduling may be performed by signaling resource set identifiers and not a specific CSI-RS resource or list of specific CSI-RS resources one by one. All the CSI-RS resources defined under a specific resource set identifier may be associated with the signaled configuration option.

As indicated above, FIG. 3B is provided as an example. Other examples may differ from what is described with respect to FIG. 3B.

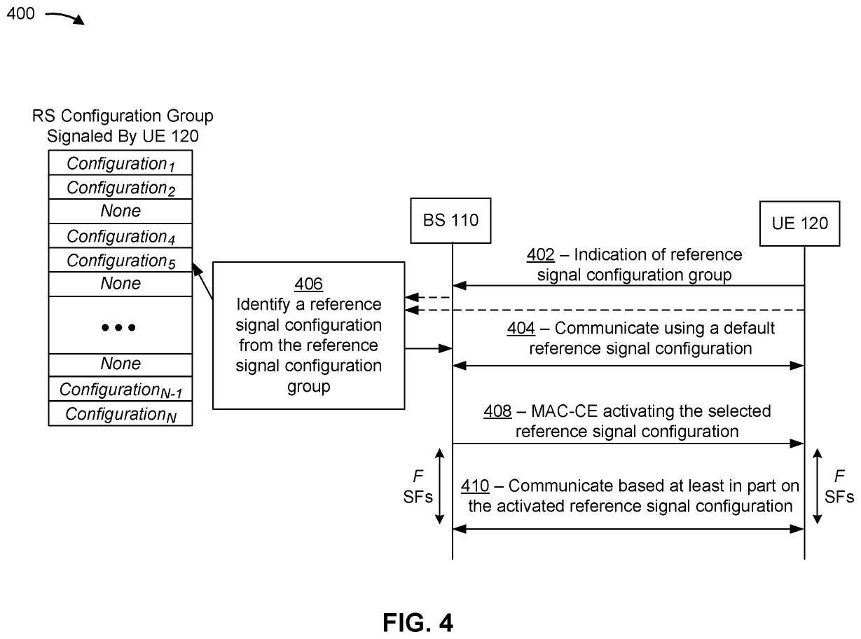

FIG. 4 is a diagram illustrating an example 400 of reference signal configuration groups and dynamic reference signal configuration selection, in accordance with various aspects of the present disclosure. As shown, a base station (e.g., BS 110) may communicate with a user equipment (e.g., UE 120) in a wireless network (e.g., wireless network 100). The BS 110 and the UE 120 may transmit one or more types of reference signals in the wireless network 100. As discussed above, types of reference signals may include a DMRS, a CSI-RS, a PTRS, SRS, TRS, and/or the like.

The BS 110 and the UE 120 may communicate using a reference signal configuration associated with a reference signal type. The reference signal configuration may indicate one or more parameters for a particular reference signal type. The one or more parameters may include a time domain resource element spacing or density parameter (e.g., a spacing between symbols for transmitting reference signals in the time domain), a frequency domain resource element spacing or density parameter (e.g., a spacing between resource elements for transmitting reference signals in the frequency domain), a power boosting parameter (e.g., relative to data transmissions associated with the reference signals to be transmitted), and/or the like.

In some aspects, a plurality of reference signal configuration groups may be defined. Each reference signal group may include a plurality of reference signal configurations. The plurality of reference signal configuration groups may be defined and configured in a similar manner as described above with respect to FIGS. 3A and 3B. In some aspects, the plurality of reference signal configuration groups may be associated with a particular reference signal type. For example, there may be a plurality of DMRS configuration groups, a plurality of CSI-RS configuration groups, a plurality of PTRS configuration groups, and/or the like.

In some aspects, each of the reference signal configuration groups may be associated with a respective UE capability. The UE capability may be based at least in part on at least one of the parameters for a particular reference signal type. In some aspects, a UE (e.g., the UE 120) may have a different capability for each reference signal type. For example, UE 120 may have a DMRS UE capability, a CSI-RS UE capability, a PTRS UE capability, and/or the like.

As shown by reference number 402, the UE 120 may transmit an indication of a reference signal configuration group of the plurality of reference signal configuration groups to the BS 110. The reference signal configuration group may be a reference signal configuration group supported by the UE 120. The UE 120 may select the reference signal configuration group from the plurality of reference signal configuration groups based at least in part on a UE capability associated with the UE 120. In some aspects, the UE 120 may identify a reference signal configuration group from the plurality of reference signal configuration groups based at least in part on the UE capability signaled by the UE 120. For example, if the UE 120 is a reduced capability UE, the UE 120 may select a reference signal configuration group that includes a lower quantity of reference signal configurations. If the UE 120 is a higher-capability UE, the UE 120 may select a reference signal configuration group that includes a greater quantity of reference signal configurations.

In some aspects, each reference signal configuration group is assigned to and/or associated with a respective UE capability (e.g., a specific UE capability category, a specific UE capability level, a specific UE capability value, and/or the like). For example, a first reference signal configuration group may be associated with a first UE capability level, a second reference signal configuration group may be associated with a second UE capability level, a third reference signal configuration group may be associated with a third UE capability level, and so on. In some aspects, the indication of a reference signal configuration group transmitted by the UE 120 to the BS 110 may be an explicit indication of the selected reference signal configuration group (e.g., may indicate an index or identifier associated with the selected reference signal configuration group). In some aspects, the indication of a reference signal configuration group transmitted by the UE 120 to the BS 110 may be an indication of the UE capability (e.g., the UE capability category, the UE capability level, the UE capability value, and/or the like) assigned to and/or associated with the selected reference signal configuration group.

As shown by reference number 404, the BS 110 and the UE 120 may communicate using a default reference signal configuration. For example, a particular reference signal type may be associated with a default reference signal configuration. The default reference signal configuration may be based at least in part on a telecommunication specification (e.g., 3GPP 5G specification), a telecommunication standard, the wireless network (e.g., wireless network 100) in which the BS 110 and the UE 120 are communicating, a configuration or capability of the BS 110, a configuration or capability of the UE 120, and/or the like. The default reference signal configuration may be used for all reference signal configuration groups and all UE capabilities. In some aspects, the UE 120 (and other UEs) and the BS 110 (and other BSs) may be instructed to support the default reference signal configuration.

The BS 110 and the UE 120 may transmit one or more downlink communications and/or one or more uplink communications using the default reference signal configuration. For example, the UE 120 may transmit one or more uplink communications to the BS 110 using the default reference signal configuration. The BS 110 may transmit one or more downlink communications to the UE 120 using the default reference signal configuration. In some aspects, the BS 110 and the UE 120 may communicate using the default reference signal configuration while the BS 110 processes the indication of the reference signal configuration group from the UE 120.

As shown by reference number 406, the BS 110 and/or the UE 120 may identify a reference signal configuration from the reference signal configuration group indicated by the UE 120. In some aspects, the UE 120 may signal or transmit an indication of the reference signal configuration to the BS 110. In some aspects, the BS 110 may identify a reference signal configuration based at least in part on a channel parameter and/or a signal to noise ratio (SNR) condition of a communication (e.g., a downlink communication and/or an uplink communication) between the BS 110 and the UE 120. For example, the BS 110 may detect the channel parameter and/or the SNR condition of a communication between the BS 110 and the UE 120. The BS 110 may dynamically select an optimal reference signal configuration from the reference signal configuration group indicated by the UE 120 based at least in part on the detected channel parameter and/or the detected SNR condition. The BS 110 may identify the reference signal configuration based on at least in part on the reference signal type associated with the communication (e.g., the BS 110 may identify a DMRS configuration, a CSI-RS configuration, a PTRS configuration, and/or the like).

As shown by reference number 408, the BS 110 may transmit an indication of the reference signal configuration identified by the BS 110 from the reference signal configuration group (e.g., the reference signal configuration group signaled as being supported by the UE 120) to the UE 120. The BS 110 may transmit the indication of the reference signal configuration in, for example, a MAC-CE communication. The MAC-CE communication may include an indication to activate the reference signal configuration identified by the BS 110 (e.g., to activate the DMRS configuration, the CSI-RS configuration, the PTRS configuration, the SRS configurations, the TRS configuration, and/or the like). In some aspects, the use of the MAC-CE communication to activate the reference signal configuration may be used for periodic CSI-RS transmissions, semi-persistent CSI-RS transmissions, and/or the like.

The MAC-CE communication may be a synchronous mechanism in that the UE 120 and the BS 110 address any configuration changes indicated by the MAC-CE communication a number of subframes (e.g., F subframes) after the MAC-CE communication is transmitted. In this way, the reference signal configuration indicated by the MAC-CE communication becomes a working assumption between the BS 110 and the UE 120. For example, the BS 110 and/or the UE 120 may activate the reference signal configuration indicated in the MAC-CE communication after F subframes (e.g., 4 subframes, 6 subframes and/or the like). As a result, after F subframes, the BS 110 and/or the UE 120 will expect to receive communications using the activated reference signal configuration. Similarly, after F subframes, the BS 110 and/or the UE 120 will transmit communications using the activated reference signal configuration.

As shown by reference number 410, the BS 110 and the UE 120 may communicate based at least in part on the activated reference signal configuration. For example, the BS 110 and the UE 120 may activate the reference signal configuration F subframes after the MAC-CE communication is transmitted. The BS 110 may transmit a downlink communication to the UE 120 using the activated reference signal configuration. The UE 120 may expect that the downlink communication received from the BS 110 will be configured using the activated reference signal configuration. Similarly, the UE 120 may transmit an uplink communication to the BS 110 using the activated reference signal configuration. The BS 110 may expect that the uplink communication received from the UE 120 will be configured using the activated reference signal configuration.

In some aspects, after sending the MAC-CE communication indicating the reference signal configuration to be activated, the BS 110 may monitor for a change in a channel parameter and/or an SNR condition of communications (e.g., downlink channel parameters and/or SNR conditions,) between the BS 110 and the UE 120. In some aspects, the UE 120 may transmit an indication of one or more channel parameters and/or SNR conditions to the BS 110, and the BS 110 may detect a change based at least in part on the signaled channel parameters and/or SNR conditions. If the BS 110 detects a change in the channel parameter and/or the SNR condition, the BS 110 may dynamically select a new optimal reference signal configuration from the reference signal configuration group indicated by the UE 120 based at least in part on the changed channel parameter and/or the changed SNR condition. In some aspects, the BS 110 may evaluate the channel parameters and/or the SNR conditions of communications between the BS 110 and the UE 120 incrementally to determine if a change in the activated reference signal configuration is appropriate. In some aspects, after sending the MAC-CE communication indicating the reference signal configuration to be activated, the BS 110 may perform DMRS adaptation on the downlink with assistance from the UE 120, where the UE 120 selects the best reference signal configuration and reports it to the BS 110. the BS 110 activates this or some number of equivalent reference signal configurations for the UE 120 to have more flexibility for the BS 110 scheduler. The BS 110 may indicate and/or activate the new reference signal configuration in a similar manner as described above (e.g., utilizing a MAC-CE communication).

As indicated above, FIG. 4 is provided as an example. Other examples may differ from what is described with respect to FIG. 4.

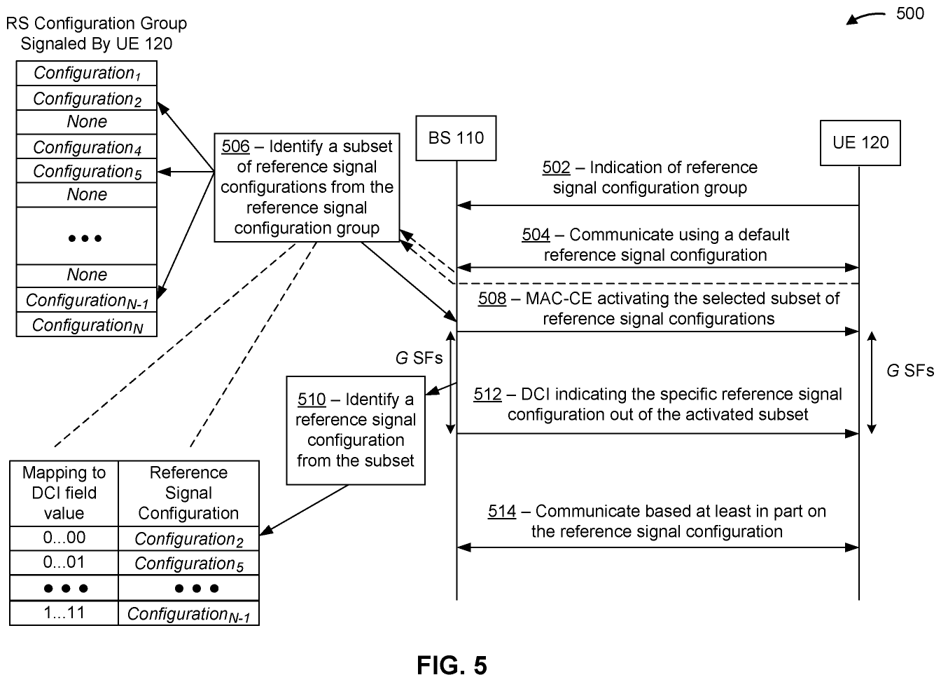

FIG. 5 is a diagram illustrating an example 500 of reference signal configuration groups and dynamic reference signal configuration selection, in accordance with various aspects of the present disclosure. As shown, a base station (e.g., BS 110) may communicate with a user equipment (e.g., UE 120) in a wireless network (e.g., wireless network 100). The BS 110 and the UE 120 may transmit one or more types of reference signals in the wireless network 100. As discussed above, types of reference signals may include a DMRS, CSI-RS, PTRS, SRS, TRS, and/or the like.

As shown by reference number 502, the UE 120 may transmit an indication of a reference signal configuration group from a plurality of reference signal configuration groups. The reference signal configuration group may be a reference signal configuration group supported by the UE 120. The UE 120 may transmit the indication of the reference signal configuration group in a similar manner as described above with respect to FIG. 4.

As shown by reference number 504, the BS 110 and the UE 120 may communicate using a default reference signal configuration. As described above, the default reference signal configuration may be used for all reference signal configuration groups and all UE capabilities. In some aspects, the UE 120 (and other UEs) and the BS 110 (and other BSs) may be instructed to support the default reference signal configuration

As shown by reference No. 506, the BS 110 and/or the UE 120 may identify a subset of reference signal configurations from the reference signal configuration group indicated by the UE 120. In some aspects, the UE 120 may signal or transmit an indication of the preferred reference signal configuration or the subset of the selected reference signal configurations to the BS 110. In some aspects, the BS 110 may identify the subset of reference signal configurations based at least in part on a channel parameter and/or a SNR condition of a communication (e.g., a downlink communication and/or an uplink communication) between the BS 110 and the UE 120. For example, the BS 110 may detect the channel parameter and/or the SNR condition of a communication between the BS 110 and the UE 120. The BS 110 may dynamically select an optimal subset of reference signal configurations from the reference signal configuration group indicated by the UE 120 based at least in part on the detected channel parameter and/or the detected SNR condition. In some aspects, the BS 110 may identify the subset of reference signal configurations based at least in part on one or more scheduling constraints of the BS 110. The BS 110 may identify the subset of reference signal configurations based on at least in part on the reference signal type associated with the communication (e.g., the BS 110 may identify a subset of DMRS configurations, a subset of CSI-RS configurations, a subset of PTRS configurations, a subset of SRS configurations, a subset of TRS configurations, and/or the like).

As shown by reference number 508, the BS 110 may transmit an indication to activate the subset of reference signal configurations. The indication to activate the subset of reference signal configurations may be included in, for example, a MAC-CE communication. The BS 110 and/or the UE 120 may activate the subset of reference signal configurations after a number (e.g., G) of subframes after the MAC-CE communication is transmitted (e.g., after G subframes, the subset of reference signal configurations become a working assumption between the BS 110 and the UE 120).

In some aspects, the BS 110 may schedule or allocate resources for a communication between the BS 110 and the UE 120 (e.g., a downlink communication, an uplink communication, and/or the like). In some aspects, the BS 110 may transmit a downlink control information DCI communication that schedules the communication (e.g., a downlink grant that schedules a downlink communication, an uplink grant that schedules an uplink communication, and/or the like). The scheduling may be a physical downlink shared channel (PDSCH) scheduling, an AP CSI-RS scheduling, physical uplink shared channel (PUSCH) scheduling, and/or the like. In some aspects, a reference signal configuration field may be defined or configured in the DCI communication. The reference signal configuration field may indicate a particular reference signal configuration out of the activated subset of the reference signal configurations to be used for the communication scheduled or allocated by the DCI communication.

As shown by reference number 510, the BS 110 may identify a reference signal configuration from the activated subset of reference signal configurations. The BS 110 may dynamically select the reference signal configuration from the activated subset of reference signal configurations based at least in part on a scheduling constraint of the BS 110, a detected channel parameter and/or a detected SNR condition of a communication between the BS 110 and the UE 120, a slot/subframe type, an allocation type, an allocation size or an allocation length, MU-MIMO scenario in the addressed slot/subframe, different logical channel multiplexing in the same slot/subframe, and/or the like.

As shown by reference number 512, the BS 110 may transmit a DCI communication that schedules a communication to be transmitted between the BS 110 to the UE 120. The DCI communication may include an indication to use the reference signal configuration for receiving a downlink reference signal associated with the communication (e.g., a downlink communication), may include an indication to use the reference signal configuration to transmit an uplink reference signal associated with the communication (e.g., an uplink communication), and/or the like. In some aspects, the use of the DCI communication to activate the reference signal configuration may be used for aperiodic CSI-RS transmissions, dynamic configuration of CSI-RS transmissions, and/or the like.

The indication may include a field, a bit string, one or more bits, and/or the like. For example, and as illustrated in FIG. 5, the indication in the DCI communication may include a DCI field value associated with the reference signal configuration. In this way, the BS 110 may dynamically select an optimal reference signal configuration from the subset of reference signal configurations for a particular communication scheduled by the DCI communication.

As shown by reference number 514, the BS 110 and the UE 120 may communicate based at least in part on the reference signal configuration indicated in the DCI communication. For example, the BS 110 may transmit a downlink reference signal associated with a downlink communication using the reference signal configuration indicated in the DCI communication. As another example, the UE 120 may transmit an uplink reference signal associated with an uplink communication using the reference signal configuration indicated in the DCI communication.

In some aspects, after sending the MAC-CE communication indicating the reference signal configuration to be activated, the BS 110 may monitor for a change in a channel parameter and/or an SNR condition of communications (e.g., downlink channel parameters and/or SNR conditions,) between the BS 110 and the UE 120. In some aspects, the UE 120 may transmit an indication of one or more channel parameters and/or SNR conditions to the BS 110, and the BS 110 may detect a change based at least in part on the signaled channel parameters and/or SNR conditions. If the BS 110 detects a change in the channel parameter and/or the SNR condition, the BS 110 may dynamically select a new optimal reference signal configuration from the reference signal configuration group indicated by the UE 120 based at least in part on the changed channel parameter and/or the changed SNR condition. In some aspects, the BS 110 may evaluate the channel parameters and/or the SNR conditions of communications between the BS 110 and the UE 120 incrementally to determine if a change in the activated reference signal configuration is appropriate. In some aspects, once the selected option/equivalent subset of options is already selected, the BS 110 may perform DMRS adaptation on the downlink with assistance from the UE 120, where the UE 120 selects the best reference signal configuration and reports it to the BS 110. the BS 110 activates this or some number of equivalent reference signal configurations for the UE 120 to have more flexibility for the BS 110 scheduler. The BS 110 may indicate and/or activate the new reference signal configuration in a similar manner as described above (e.g., utilizing a MAC-CE communication).

As indicated above, FIG. 5 is provided as an example. Other examples may differ from what is described with respect to FIG. 5.

FIG. 6 is a diagram illustrating an example process 600 performed, for example, by a user equipment (UE), in accordance with various aspects of the present disclosure. Example process 600 is an example where the user equipment (e.g., user equipment 120 and/or the like) performs operations associated with signaling supported reference signal configuration group(s) and receiving dynamic reference signal configuration for communication with a BS.

As shown in FIG. 6, in some aspects, process 600 may include transmitting, to a base station (BS), an indication of a reference signal configuration group of a plurality of reference signal configuration groups (block 610). For example, the UE (e.g., using receive processor 258, transmit processor 264, controller/processor 280, memory 282, and/or the like) may transmit, to a BS, an indication of a reference signal configuration group of a plurality of reference signal configuration groups, as described above.

As further shown in FIG. 6, in some aspects, process 600 may include receiving, from the BS, an indication of a reference signal configuration from the signaled by a UE reference signal configuration group (block 620). For example, the UE (e.g., using receive processor 258, transmit processor 264, controller/processor 280, memory 282, and/or the like) may receive, from the BS, an indication of a reference signal configuration from the reference signal configuration group, as described above.

As further shown in FIG. 6, in some aspects, process 600 may include communicating with the BS using the reference signal configuration based at least in part on the indication of the reference signal configuration (block 630). For example, the UE (e.g., using receive processor 258, transmit processor 264, controller/processor 280, memory 282, and/or the like) may communicate with the BS using the reference signal configuration based at least in part on the indication of the reference signal configuration, as described above.

Process 600 may include additional aspects, such as any single aspect or any combination of aspects described below and/or in connection with one or more other processes described elsewhere herein.

In a first aspect, the reference signal configuration defines one or more parameters for a particular a reference signal type, and a combination of the one or more parameters are associated with a reference signal identifier associated with the reference signal configuration include at least one of a time domain resource element spacing or density for the reference signal type, a frequency domain resource element spacing or density for the reference signal type, or a power boosting parameter for the reference signal type.

In a second aspect, alone or in combination with the first aspect, the reference signal type is a DMRS.

In a third aspect, alone or in combination with one or more of the first and second aspects, each of the plurality of reference signal configuration groups includes a different combination of a full list of reference signal configurations that are defined.

In a fourth aspect, alone or in combination with one or more of the first through third aspects, each of the plurality of reference signal configuration groups includes a different quantity of reference signal configurations.

In a fifth aspect, alone or in combination with one or more of the first through fourth aspects, process 600 includes identifying the reference signal configuration group from the plurality of reference signal configuration groups based at least in part on a UE capability signaled by the UE, wherein the UE capability is associated with the reference signal configuration group, and wherein indication of the reference signal configuration group is an indication of the UE capability.

In a sixth aspect, alone or in combination with one or more of the first through fifth aspects, the reference signal configuration groups are DMRS configuration groups or CSI-RS configuration groups, and receiving the indication of the reference signal configuration comprises receiving, in a MAC-CE communication, an indication to activate a particular DMRS configuration or a particular CSI-RS configuration; and wherein communicating with the BS using the reference signal configuration comprises activating the DMRS configuration or the CSI-RS configuration based at least in part on receiving the indication to activate the DMRS configuration or the CSI-RS configuration; and communicating with the BS using the DMRS configuration or the CSI-RS configuration based at least in part on activating the DMRS configuration or the CSI-RS configuration. The CSI-RS configuration may be a configuration associated with a periodic and/or semi-persistent CSI-RS.

In a seventh aspect, alone or in combination with one or more of the first through sixth aspects, activating the DMRS configuration or the CSI-RS configuration comprises activating the DMRS configuration or the CSI-RS configuration after a particular quantity of subframes from receiving the MAC-CE communication such that the DMRS configuration or the CSI-RS configuration is addressed by the UE and by the BS after the particular quantity of subframes from receiving the MAC-CE communication.

In an eighth aspect, alone or in combination with one or more of the first through seventh aspects, process 600 includes, prior to is activating the DMRS configuration or the CSI-RS configuration and prior to providing other RRC parameters associated with the DMRS configuration or the CSI-RS configuration, at least one of receiving one or more other downlink communications using a default reference signal configuration, or transmitting one or more uplink communications using the default reference signal configuration.

In a ninth aspect, alone or in combination with one or more of the first through eighth aspects, process 600 includes receiving, from the BS and in a MAC-CE communication, a first indication to activate a subset of reference signal configurations included in the reference signal configuration group, wherein the reference signal configuration is to be signaled and used for further allocations, and is included in the subset of reference signal configurations; and activating the subset of reference signal configurations based at least in part on receiving the first indication; and wherein receiving the indication of the reference signal configuration comprises receiving, in a DCI communication that schedules a communication to be transmitted or received by the UE, a second indication to use the reference signal configuration from the activated subset of reference signal configurations for receiving or transmitting a reference signal scheduled by the DCI.

In a tenth aspect, alone or in combination with one or more of the first through ninth aspects, activating the subset of reference signal configurations comprises activating the subset of reference signal configurations after a particular quantity of subframes from receiving the MAC-CE communication.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a BS, in accordance with various aspects of the present disclosure. Example process 700 is an example where the BS (e.g., base station 110 and/or the like) performs operations associated with receiving an indication for a supported reference signal configuration group(s) from a UE and dynamically selecting and signaling to the UE the reference signal configuration for DL and UL communications with the UE.

As shown in FIG. 7, in some aspects, process 700 may include receiving, from a UE, an indication of a reference signal configuration group of a plurality of reference signal configuration groups (block 710). For example, the BS (e.g., using transmit processor 220, receive processor 238, controller/processor 240, memory 242, and/or the like) may receive, from a UE, an indication of a reference signal configuration group of a plurality of reference signal configuration groups, as described above.

As further shown in FIG. 7, in some aspects, process 700 may include transmitting, to the UE, an indication of a reference signal configuration from the reference signal configuration group (block 720). For example, the BS (e.g., using transmit processor 220, receive processor 238, controller/processor 240, memory 242, and/or the like) may transmit, to the UE, an indication of a reference signal configuration from the reference signal configuration group, as described above. In some aspects, the reference signal configuration group is a reference signal configuration group supported by the UE and is associated with a UE capability signaled by the UE.

As further shown in FIG. 7, in some aspects, process 700 may include communicating with the UE using the reference signal configuration after transmitting the indication of the reference signal configuration (block 730). For example, the BS (e.g., using transmit processor 220, receive processor 238, controller/processor 240, memory 242, and/or the like) may communicate with the UE using the reference signal configuration after transmitting the indication of the reference signal configuration, as described above.

Process 700 may include additional aspects, such as any single aspect or any combination of aspects described below and/or in connection with one or more other processes described elsewhere herein.

In a first aspect, the reference signal configuration defines one or more parameters for a particular a reference signal type, and a combination of the one or more parameters are associated with a reference signal identifier associated with the reference signal configuration include at least one of a time domain resource element spacing or density for the reference signal type, a frequency domain resource element spacing or density for the reference signal type, or a power boosting parameter for the reference signal type.

In a second aspect, alone or in combination with the first aspect, the reference signal type is a DMRS.

In a third aspect, alone or in combination with one or more of the first and second aspects, each of the plurality of reference signal configuration groups includes a different combination of a full list of reference signal configurations that are defined.

In a fourth aspect, alone or in combination with one or more of the first through third aspects, each of the plurality of reference signal configuration groups includes a different quantity of reference signal configurations.

In a fifth aspect, alone or in combination with one or more of the first through fourth aspects, the reference signal configuration group is based at least in part on a UE capability associated with the UE, wherein the UE capability is associated with the reference signal configuration group, and wherein indication of the reference signal configuration group is an indication of the UE capability.

In a sixth aspect, alone or in combination with one or more of the first through fifth aspects, the reference signal configuration groups are DMRS configuration groups or CSI-RS configuration groups, and transmitting the indication of the reference signal configuration comprises transmitting, in a MAC-CE communication, an indication to activate a particular DMRS configuration or a particular CSI-RS configuration; and wherein communicating with the UE using the reference signal configuration comprises activating the DMRS configuration or the CSI-RS configuration based at least in part on transmitting the indication to activate the DMRS configuration or the CSI-RS configuration; and communicating with the UE using the DMRS configuration or the CSI-RS configuration based at least in part on activating the DMRS configuration or the CSI-RS configuration.

In a seventh aspect, alone or in combination with one or more of the first through sixth aspects, activating the DMRS configuration or the CSI-RS configuration comprises activating the DMRS configuration or the CSI-RS configuration after a particular quantity of subframes from transmitting the MAC-CE communication such that the DMRS configuration or the CSI-RS configuration is addressed by the B S and by the UE after the particular quantity of subframes from receiving the MAC-CE communication.

In an eighth aspect, alone or in combination with one or more of the first through seventh aspects, process 700 includes, prior to is activating the DMRS configuration or the CSI-RS configuration and prior to receiving other RRC parameters associated with the DMRS configuration or the CSI-RS configuration, at least one of receiving one or more other uplink communications using a default reference signal configuration, or transmitting one or more downlink communications using the default reference signal configuration.

In a ninth aspect, alone or in combination with one or more of the first through eighth aspects, process 700 includes transmitting, to the UE and in a MAC-CE communication, a first indication to activate a subset of reference signal configurations included in the reference signal configuration group, wherein the reference signal configuration is to be signaled and used for further allocations, and is included in the subset of reference signal configurations; and activating the subset of reference signal configurations based at least in part on transmitting the first indication; and wherein transmitting the indication of the reference signal configuration comprises transmitting, in a DCI communication that schedules a communication to be transmitted to or received by the BS, a second indication to use the reference signal configuration from the activated subset of reference signal configurations for receiving or transmitting a reference signal scheduled by the DCI.

In a tenth aspect, alone or in combination with one or more of the first through ninth aspects, activating the subset of reference signal configurations comprises activating the subset of reference signal configurations after a particular quantity of subframes from transmitting the MAC-CE communication.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software.

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, firmware, or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication performed by a user equipment (UE), comprising:
transmitting, to a base station (BS), an indication of a reference signal configuration group of a plurality of reference signal configuration groups;
receiving, from the BS, an indication of a reference signal configuration from the reference signal configuration group; and
communicating with the BS using the reference signal configuration based at least in part on the indication of the reference signal configuration.

2. The method of claim 1, wherein the reference signal configuration defines one or more parameters for a particular a reference signal type; and
wherein a combination of the one or more parameters are associated with a reference signal identifier associated with the reference signal configuration include at least one of:
a time domain resource element spacing or density for the reference signal type,
a frequency domain resource element spacing or density for the reference signal type, or
a power boosting parameter for the reference signal type.

3. The method of claim 2, wherein the reference signal type is a demodulation reference signal (DMRS).

4. The method of claim 1, wherein each of the plurality of reference signal configuration groups includes a different combination of a full list of reference signal configurations that are defined.

5. The method of claim 1, wherein each of the plurality of reference signal configuration groups includes a different quantity of reference signal configurations.

6. The method of claim 1, further comprising:
identifying the reference signal configuration group from the plurality of reference signal configuration groups based at least in part on a UE capability signaled by the UE,
wherein the UE capability is associated with the reference signal configuration group, and
wherein indication of the reference signal configuration group is an indication of the UE capability.

7. The method of claim 1, wherein the reference signal configuration groups are demodulation reference signal (DMRS) configuration groups or channel state information reference signal (CSI-RS) configuration groups; and
wherein receiving the indication of the reference signal configuration comprises:
receiving, in a medium access control control element (MAC-CE) communication, an indication to activate a particular DMRS configuration or a particular CSI-RS configuration; and
wherein communicating with the BS using the reference signal configuration comprises:
activating the DMRS configuration or the CSI-RS configuration based at least in part on receiving the indication to activate the DMRS configuration or the CSI-RS configuration; and
communicating with the BS using the DMRS configuration or the CSI-RS configuration based at least in part on activating the DMRS configuration or the CSI-RS configuration.

8. The method of claim 7, wherein activating the DMRS configuration or the CSI-RS configuration comprises:
activating the DMRS configuration or the CSI-RS configuration after a particular quantity of subframes from receiving the MAC-CE communication such that the DMRS configuration or the CSI-RS configuration is used by the UE after the particular quantity of subframes from receiving the MAC-CE communication.

9. The method of claim 7, further comprising:
prior to activating the DMRS configuration or the CSI-RS configuration and prior to providing other radio resource control (RRC) parameters associated with the DMRS configuration or the CSI-RS configuration, at least one of:
receiving one or more other downlink communications using a default reference signal configuration, or
transmitting one or more uplink communications using the default reference signal configuration.

10. The method of claim 1, further comprising:
receiving, from the BS and in a medium access control control element (MAC-CE) communication, a first indication to activate a subset of reference signal configurations included in the reference signal configuration group,
wherein the reference signal configuration is to be signaled and used for further allocations, and is included in the subset of reference signal configurations; and
activating the subset of reference signal configurations based at least in part on receiving the first indication; and
wherein receiving the indication of the reference signal configuration comprises:
receiving, in a downlink control information (DCI) communication that schedules a communication to be transmitted or received by the UE, a second indication to use the reference signal configuration from the activated subset of reference signal configurations for receiving or transmitting a reference signal scheduled by the DCI.

11. The method of claim 10, wherein activating the subset of reference signal configurations comprises:
activating the subset of reference signal configurations after a particular quantity of subframes from receiving the MAC-CE communication.

12. A method of wireless communication performed by a base station (BS), comprising:
receiving, from a user equipment (UE), an indication of a reference signal configuration group of a plurality of reference signal configuration groups;
transmitting, to the UE, an indication of a reference signal configuration from the reference signal configuration group; and
communicating with the UE using the reference signal configuration after transmitting the indication of the reference signal configuration.

13. The method of claim 12, wherein the reference signal configuration defines one or more parameters for a particular a reference signal type; and
wherein a combination of the one or more parameters are associated with a reference signal identifier associated with the reference signal configuration include at least one of:
a time domain resource element spacing or density for the reference signal type,
a frequency domain resource element spacing or density for the reference signal type, or
a power boosting parameter for the reference signal type.

14. The method of claim 13, wherein the reference signal type is a demodulation reference signal (DMRS).

15. The method of claim 12, wherein each of the plurality of reference signal configuration groups includes a different combination of a full list of reference signal configurations that are defined.

16. The method of claim 12, wherein each of the plurality of reference signal configuration groups includes a different quantity of reference signal configurations.

17. The method of claim 12, wherein the reference signal configuration group is based at least in part on a UE capability associated with the UE;
wherein the UE capability is associated with the reference signal configuration group, and
wherein indication of the reference signal configuration group is an indication of the UE capability.

18. The method of claim 12, wherein the reference signal configuration groups are demodulation reference signal (DMRS) configuration groups or channel state information reference signal (CSI-RS) configuration groups; and
wherein transmitting the indication of the reference signal configuration comprises:
transmitting, in a medium access control control element (MAC-CE) communication, an indication to activate a particular DMRS configuration or a particular CSI-RS configuration; and
wherein communicating with the UE using the reference signal configuration comprises:
activating the DMRS configuration or the CSI-RS configuration based at least in part on transmitting the indication to activate the DMRS configuration or the CSI-RS configuration; and
communicating with the UE using the DMRS configuration or the CSI-RS configuration based at least in part on activating the DMRS configuration or the CSI-RS configuration.

19. The method of claim 18, wherein activating the DMRS configuration or the CSI-RS configuration comprises:
activating the DMRS configuration or the CSI-RS configuration after a particular quantity of subframes from transmitting the MAC-CE communication such that the DMRS configuration or the CSI-RS configuration is used by the BS after the particular quantity of subframes from receiving the MAC-CE communication.

20. The method of claim 18, further comprising:
prior to activating the DMRS configuration or the CSI-RS configuration and prior to receiving other radio resource control (RRC) parameters associated with the DMRS configuration or the CSI-RS configuration, at least one of:
receiving one or more other uplink communications using a default reference signal configuration, or
transmitting one or more downlink communications using the default reference signal configuration.

21. The method of claim 12, further comprising:
d.

[symbol]

22. The method of claim 21, wherein activating the subset of reference signal configurations comprises:
activating the subset of reference signal configurations after a particular quantity of subframes from transmitting the MAC-CE communication.

23. A user equipment (UE) for wireless communication, comprising:
a memory; and
one or more processors operatively coupled to the memory, the memory and the one or more processors configured to:
transmit, to a base station (BS), an indication of a reference signal configuration group of a plurality of reference signal configuration groups;
receive, from the BS, an indication of a reference signal configuration from the reference signal configuration group; and
communicate with the BS using the reference signal configuration based at least in part on the indication of the reference signal configuration.

24. The UE of claim 23, wherein the reference signal configuration defines one or more parameters for a particular a reference signal type; and
wherein a combination of the one or more parameters are associated with a reference signal identifier associated with the reference signal configuration include at least one of:
a time domain resource element spacing or density for the reference signal type,
a frequency domain resource element spacing or density for the reference signal type, or
a power boosting parameter for the reference signal type.

25. The UE of claim 23, wherein the reference signal configuration groups are demodulation reference signal (DMRS) configuration groups or channel state information reference signal (CSI-RS) configuration groups; and
wherein the one or more processors, when receiving the indication of the reference signal configuration, are configured to:
receive, in a medium access control control element (MAC-CE) communication, an indication to activate a particular DMRS configuration or a particular CSI-RS configuration; and
wherein the one or more processors, when communicating with the BS using the reference signal configuration, are configured to:
activate the DMRS configuration or the CSI-RS configuration based at least in part on receiving the indication to activate the DMRS configuration or the CSI-RS configuration; and
communicate with the BS using the DMRS configuration or the CSI-RS configuration based at least in part on activating the DMRS configuration or the CSI-RS configuration.

26. The UE of claim 23, wherein the one or more processors are further configured to:
receive, from the BS and in a MAC-CE communication, a first indication to activate a subset of reference signal configurations included in the reference signal configuration group,
wherein the reference signal configuration is to be signaled and used for further allocations, and is included in the subset of reference signal configurations; and
activate the subset of reference signal configurations based at least in part on receiving the first indication; and
wherein the one or more processors, when receiving the indication of the reference signal configuration, are configured to:
receive, in a downlink control information (DCI) communication that schedules a communication to be transmitted or received by the UE, a second indication to use the reference signal configuration from the activated subset of reference signal configurations for receiving or transmitting a reference signal scheduled by the DCI.

27. A base station (BS) for wireless communication, comprising:
a memory; and
one or more processors operatively coupled to the memory, the memory and the one or more processors configured to:
receive, from a user equipment (UE), an indication of a reference signal configuration group of a plurality of reference signal configuration groups;
transmit, to the UE, an indication of a reference signal configuration from the reference signal configuration group; and
communicate with the UE using the reference signal configuration after transmitting the indication of the reference signal configuration.

28. The BS of claim 27, wherein the reference signal configuration defines one or more parameters for a particular a reference signal type; and
wherein a combination of the one or more parameters are associated with a reference signal identifier associated with the reference signal configuration include at least one of:
a time domain resource element spacing or density for the reference signal type,
a frequency domain resource element spacing or density for the reference signal type, or
a power boosting parameter for the reference signal type.

29. The BS of claim 27, wherein the reference signal configuration groups are demodulation reference signal (DMRS) configuration groups or channel state information reference signal (CSI-RS) configuration groups; and
wherein the one or more processors, when transmitting the indication of the reference signal configuration, are configured to:
transmit, in a medium access control control element (MAC-CE) communication, an indication to activate a particular DMRS configuration or a particular CSI-RS configuration; and
wherein the one or more processors, when communicating with the UE using the reference signal configuration, are configured to:
activate the DMRS configuration or the CSI-RS configuration based at least in part on transmitting the indication to activate the DMRS configuration or the CSI-RS configuration; and
communicate with the UE using the DMRS configuration or the CSI-RS configuration based at least in part on activating the DMRS configuration or the CSI-RS configuration.

30. The BS of claim 27, wherein the one or more processors are further configured to:
transmit, to the UE and in a medium access control control element (MAC-CE) communication, a first indication to activate a subset of reference signal configurations included in the reference signal configuration group,
wherein the reference signal configuration is to be signaled and used for further allocations, and is included in the subset of reference signal configurations; and
activate the subset of reference signal configurations based at least in part on transmitting the first indication; and
wherein the one or more processors, when transmitting the indication of the reference signal configuration, are configured to:
transmit, in a downlink control information (DCI) communication that schedules a communication to be transmitted to or received by the BS, a second indication to use the reference signal configuration from the activated subset of reference signal configurations for receiving or transmitting a reference signal scheduled by the DCI.
